(19) United States
(12) Patent Application Publication
(10) Pub. No.: US 2017/0210651 A1
(43) Pub. Date: Jul. 27, 2017

(54) Pulsating, horizontal flow wastewater treatment system

(71) Applicant: Jochen Schroer, Hanwell (CA)

(72) Inventor: Jochen Schroer, Hanwell (CA)

(21) Appl. No.: 14/998,637

(22) Filed: Jan. 27, 2016

(51) Int. Cl. C02F 3/04; C02F 3/28; C02F 3/22

(52) U.S. Cl. CPC C02F 3/043; C02F 3/046; C02F 3/22; C02F 3/288

(57) ABSTRACT

The pulsating horizontal flow absorption bed comprises an array of permeable filtration elements enclosing filtering media. The array of permeable filtration elements includes a first upstream filtration element and a last downstream filtration element; a plateau of granular materiel under the array of filtration elements; an air-permeable layer above the array of filtration elements; a wastewater delivery pipe mounted in the first filtration element; and a pulsating device connected to the array of filtration elements for sequentially increasing and lowering a level of wastewater is the filtration elements. The filtering media in the filtration elements is sequentially exposed to wastewater and air. In another aspect, the filtration elements have permeable walls there between, and these walls are mounted parallel to the wastewater delivery pipe, such that resistance to flow increases through the array of filtration elements and such that treatment efficiency increases according to wastewater content.

The present application claims the benefit of U.S. Provisional Application No. 62/125,741, filed Jan. 30, 2015.

### FIELD OF THE INVENTION

This invention pertains to wastewater treatment systems, and more particularly the present invention pertains to pulsating septic effluent treatment and absorption beds.

### BACKGROUND OF THE INVENTION

A conventional system for on-site treatment of domestic sewage and wastewater in a rural residence includes a septic tank and an array of perforated pipes laid in the soil, forming an effluent absorption bed. The solid portion of the sewage is treated in the septic tank by settling and anaerobic digestion. The remaining septic effluent is treated in the effluent absorption bed by aerobic filtration and evaporation-transpiration or by absorption and dissipation to the earth.

Examples of conventional wastewater treatment systems in the prior art include:

U.S. Pat. No. 5,017,040 issued to Edward B. Mott on May 21, 1991;
U.S. Pat. No. 5,597,264 issued to Rein Laak on Jan. 28, 1997;
U.S. Pat. No. 5,707,513 issued to F. Craig Jowett et al., on Jan. 13, 1998;
U.S. Pat. No. 5,738,781 issued to Terumi Carlson on Apr. 14, 1998;
U.S. Pat. No. 6,190,545 issued to J. Kelly Williamson on Feb. 20, 2001;
U.S. Pat. No. 6,428,691 issued to Charles Wofford on Aug. 6, 2002;
U.S. Pat. No. 7,344,641 issued to Edward Gresko on Mar. 18, 2008;
U.S. Pat. No. 7,465,390 issued to David A. Potts on Dec. 16, 2008.
Canadian Patent 2,284,215 issued to Alan Hassett, on Nov. 28, 2006;

Generally, the installation and operation of the septic tank in a wastewater treatment system does not represent any difficulty. The tank is installed in the ground near the building to be serviced, at an appropriate depth where the wastewater can flow into the tank by gravity.

The design and construction of an effluent absorption bed, however, often represent the most challenges. The backyard of a residence may be too small or too steep to accommodate such absorption bed. The soil may be rocky or contain too much clay. Decorative trees need to be saved. The groundwater table may be too close to the surface. Right-of-ways cannot be used, just to mentioned a few examples of the challenges encountered.

Conventional wastewater absorption beds often require from 60 to 150 meters (200 to 500 linear feet) of drainage pipe, arranged in parallel branches of 15 meters (50 feet) in length, spaced apart 1.5 meters (1.6 yards). That is to say, a conventional wastewater absorption bed takes up a large portion of a residential lot.

Conventional wastewater absorption systems rely on existing soil to treat and evacuate the effluent. All soils are different and soil absorption behavior over the long term is difficult to predict. Therefore a large safety factor is required in the design, leading to over-design of the absorption bed, making the system unnecessary costly.

Often the construction of an effluent absorption bed requires sand, crushed rock, other fill material and top soil to be brought in from long distances. Suitable sand is costly and in limited supply in some regions. Excavation and trucking of the construction materials for the septic treatment system also adds a substantial amount to the cost of a new home.

Because of these inconveniences, there is a need in the rural housing industry for a wastewater absorption bed that has a relatively small surface area, and that pre-treats the effluent more efficiently than the conventional wastewater absorption beds available in the prior art.

In relation with the above, it is believed that an important characteristic of aerobic activity has been overlooked in the past in the design of septic fields. For illustration purposes, the rotting of a wood post is used as an example. This characteristic can be observed on fence posts and wooden clothes line posts for examples. Degradation by rotting can be observed at the surface of the soil (in the vadose zone) where the wood of the post is alternately exposed to moisture and air. The wood of the post absorbs moisture during a rainy period and dries during sunny and warm periods. Degradation by rotting and aerobic activity is significantly more evident at that location, than in the air above the soil or in the underlying soil, where moisture is always present. The portions of the post deep in the ground and above ground surface experience significantly less bio-degradation activity. The same phenomenon can be observed on the wood of piles set in the ocean along a shoreline. Degradation by rotting is significantly more visible along the portion of the pile that is alternately wetted by the tides and dried by the sun.

Based on this principle, it is believed that there is a need in the field of wastewater absorption beds of septic treatment systems to increase efficiency by sequentially exposing the effluent to water and air. It is believed that such a pulsating action in the inflow or outflow of wastewater to or from an absorption bed can promote increased biological activities and degradation of contaminants within the absorption bed. It is believed that such a pulsating action can support a reduction in the surface area required by such absorption beds.

### SUMMARY OF THE PRESENT INVENTION

In the present invention, there is provided a pulsating, horizontally aligned, aerobic wastewater absorption bed. Wastewater is delivered to or withdrawn from the absorption bed into specific volumes at irregular time intervals. The bed is filled with filtration media suitable to grow aerobic bacteria. Wastewater migrates through the field in a plug-flow fashion and contaminants are being removed through a combination of settling, filtration and bio-degradation. The pulsating action of the wastewater in the absorption bed leads to sequentially wetting and drying of the filtering media, resulting in improved treatment efficiency. The filtering media provides increased contact time between the wastewater and micro-organisms. Treated effluent emerges on the downstream end of the treatment layer and is disposed off in an integrated on-site absorption field. Aeration may be passive or with forced air. The system is characterized by a large volume to surface ratio. Separation between the various layers is achieved using synthetic liners.

In a first aspect of the present invention, there is provided a pulsating horizontal flow effluent absorption bed for a septic system. The absorption bed comprises an array of permeable filtration elements containing filtering media. The array of permeable filtration elements includes a first upstream filtration element and a last downstream filtration element; a plateau of granular materiel under the array of filtration elements; an air-permeable layer above the array of filtration elements; a wastewater delivery pipe mounted in the first filtration element; and a pulsating device connected to the wastewater delivery pipe for delivering specific volumes of wastewater to be treated at timed intervals into the wastewater delivery pipe. The filtering media in the filtration elements is sequentially exposed to wastewater and air.

Alternatively, a pulsating device is mounted to the last downstream filtration element to sequentially fill and empty the downstream filtration element with effluent at irregular time intervals, thereby sequentially exposing the filtrating media in the entire absorption bed to air and wastewater.

In a second aspect of the present invention, there is provided a pulsating horizontal flow effluent absorption bed for a septic system, as mentioned above wherein the filtration elements have permeable walls there between, and these walls are mounted parallel to the wastewater delivery pipe. The resistance to horizontal flow increases through the array of filtration elements and treatment efficiency increases in the upstream filtration elements where the foul matter content in the effluent is higher.

In yet another aspect of the present invention, there is provided a method for treatment of wastewater in a effluent absorption bed. This method comprises the steps of sequentially submerging filtering media in wastewater and exposing said filtering media to air.

The wastewater absorption bed according to the present invention is charged equally over its entire area resulting in better treatment performance. Effluent percolates horizontally through a fixed filtering media that have uniform and well understood characteristics. Travel times and treatment performance are well known. Sequentially wetting and drying the filtering media to wastewater and air leads to better bio-degradation of the effluent in the bed.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the pulsating, horizontal flow wastewater treatment system according to the present invention is described with the aid of the accompanying drawings, in which like numerals denote like parts throughout the several views:

FIG. 1 is a general layout of a pulsating horizontal flow wastewater treatment system according to a preferred embodiment of the present invention;

FIG. 2 is a plan view of the preferred pulsating horizontal flow wastewater absorption bed;

FIG. 3 is an enlarged cross-section view of the absorption bed of FIG. 2, as seen in the detail circle 3 in FIG. 4;

FIG. 4 is a cross-section view of the entire pulsating horizontal flow wastewater absorption bed in the preferred wastewater treatment system as seen along line 4-4 in FIG. 2;

FIG. 5 is a plan view of a filtration bag filled with filtration media, and which constitute each filtration element in the preferred pulsating horizontal flow wastewater absorption bed;

FIG. 6 is an elevation view of the filtration bag illustrated of FIG. 5;

FIG. 7 is a flat pattern of the permeable geotextile fabric material for making the filtration bag of FIGS. 5 and 6;

FIG. 8 is a perspective view of one absorbent element contained in the filtration media in the filtration bag of FIGS. 5 and 6.

The drawings presented herein are provided for convenience to explain the functions of all the elements included in the preferred embodiment of the present invention. Elements and details that are obvious to the person skilled in the art may not have been illustrated. Conceptual sketches have been used to illustrate elements that would be readily understood in the light of the present disclosure. These drawings are not fabrication drawings, and should not be scaled.

### DESCRIPTION OF THE PREFERRED EMBODIMENT

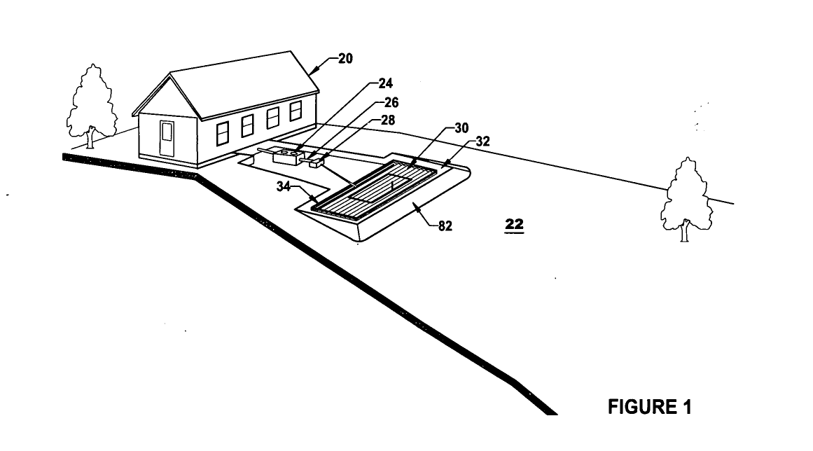

Referring firstly to FIG. 1, the general layout of a pulsating, horizontal flow wastewater absorption bed is illustrated. The rural residence 20 which is illustrated in this drawing has a slopping backyard 22. This lot is normally considered inappropriate to accommodate a large conventional wastewater treatment field. Because the wastewater treatment system according to the preferred embodiment of the present invention is efficient and has a large volume to surface ratio, it is possible to construct such system on a relatively small surface area.

In the illustrated example, a septic tank 24 is installed near the residence 20. The installation of the septic tank 24 is done according to conventional methods. The overflow pipe 26 of the septic tank is connected to a pulsating device 28, which in turn is connected to the upstream end of the preferred wastewater absorption bed 30. The preferred wastewater absorption bed 30 is built on a plateau 32 of screened gravel or crushed rock material.

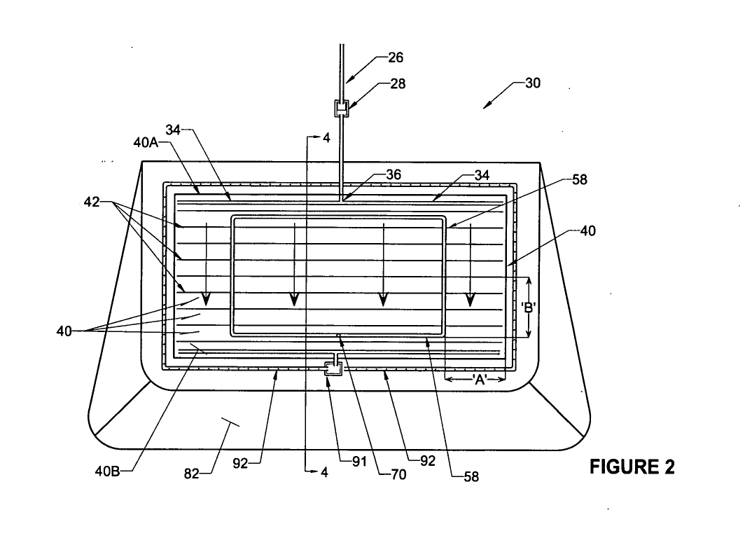

The effluent absorption bed 30 according to the preferred embodiment has one perforated header pipe 34 connected to the pulsating or dosing device 28 by a T-connection 36. The header pipe 34 is laid inside a first filtration element 40A, as can be seen in FIG. 2. Both ends of the header pipe 34 are capped so that wastewater is distributed equally along the first filtration element 40A.

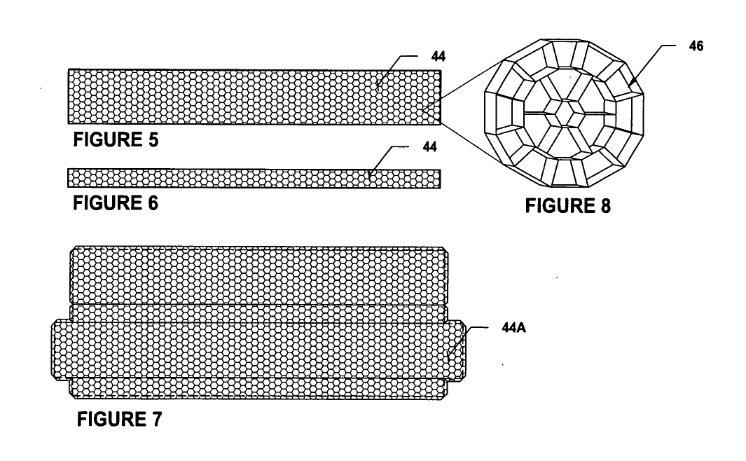

The horizontal flow wastewater absorption bed 30 according to the preferred embodiment comprises a series of juxtaposed such filtration elements 40. Each filtration element 40 is made of a permeable geotextile bag 44 filled with plastic discs 46. Each filtration element 40 has a thickness and raised sides 42. As it will be understood the sides 42 of the bags 44 are also made of permeable geotextile material and juxtaposed sides 42 constitute a double-layer permeable wall between two juxtaposed filtration elements 40. The permeable geotextile bag 44, the flat pattern 44A of the geotextile bag 44, and the discs 46 of the filtering media are illustrated in FIGS. 5-8.

These plastic discs 46 in the geotextile bags 44, are made of a plurality of honeycomb-like alveolations, that have the ability to retain water therein by capillary action or by surface tension between the water and the plastic material of the discs 46.

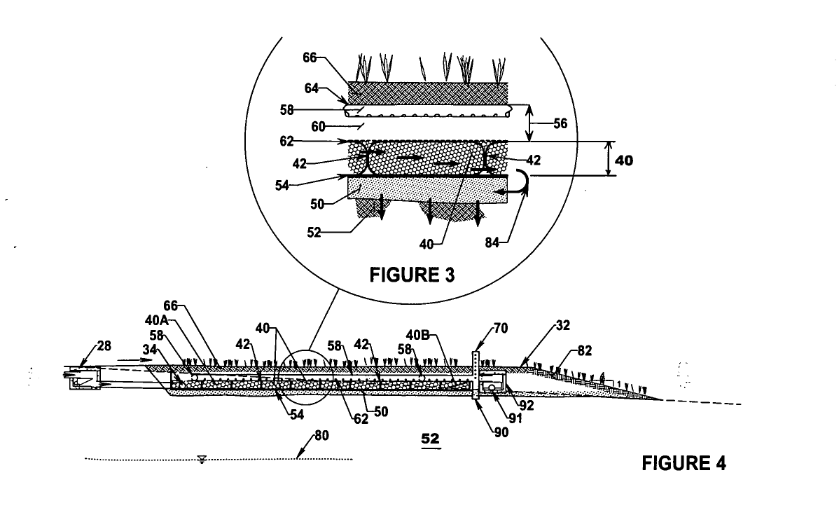

Referring back to FIG. 3, each filtration element 40 preferably has a three-dimensional rectangular shape. The filtration elements 40 are mounted on a horizontal surface of sand, screened gravel or crushed rock base layer 50. The base layer 50 is laid on an existing ground surface 52 that has been scarified and leveled.

Vertically, the filtration elements 40 are separated from the crushed rock layer 50 by a high-density polyethylene sheet 54 laid under the filtration elements 40. An aeration layer 56 is laid on the top of the filtration elements 40.

The upper aeration layer 56 contains a perforated aeration pipe 58 embedded in sand 60 or other air-permeable filler material between a lower woven geotextile sheet 62 over the filtration elements 40 and an upper non-woven geotextile sheet 64. The non-woven geotextile sheet 64 is less permeable than the woven type 62. The aeration layer 56 and the non-woven geotextile layer 64 are covered with a layer of topsoil or sod 66.

Referring back to FIG. 2, the aeration pipe 58 forms a loop over the array of filtration elements 40. The loop formed by the aeration pipe 58 has dimensions so that aeration is available in a same amount to all portions of the wastewater absorption bed 30. For example, the distance “A” from a transverse segment of the aeration pipe 58 to the end of the filtration elements 40 is a same dimension as the space “B” between a longitudinal segment of the aeration pipe 58 and a mid-point of the array of filtration elements 40.

Referring now to FIG. 4, the aeration pipe 58 has a vent 70 there along to allow air into the pipe 58. The vent 70 is preferably located near the last filtration element 40B. The vent 70 is also used as an inspection port to monitor water quality and to take samples of the . 10 effluent near the last filtration element 40B. Air enters into the aeration pipe 58 naturally by the lowering of the wastewater in the filtration elements 40 or may be forced in by an air blower (not shown) for example.

It will be appreciated that the wastewater absorption bed 30 is built above the ground-water table 80, and the apron 82 of the bed has a slope of about 1 to 4. The wastewater flowing through the walls of the last filtration element 40B seeps into the base layer 50 of sand, crushed rock and screened gravel and dissipates into the soil 52 of the plateau 32, as can be understood by reverse-flow arrow 84 in FIG. 3.

The dashed line 90 in FIG. 4, represents surges of wastewater during a pulsating cycle inside the effluent absorption bed 30. The pulsating device 28 is preferably made of a tipping bucket such as described in U.S. Pat. No. 4,838,731, issued to N. Gavin on Jun. 13, 1989. Another dosing device that can be used as a pulsating devise for use in the present system is described in U.S. Pat. No. 5,290,434 issued to J. G. Richard on Mar. 1, 1994. A dosing pump may also be used.

Pulsating action can also be obtained by installing a water withdrawal mechanism 91 at the outlet of the array of filtration elements. In this alternate installation, the mechanism empties the bed once it has filled the filtration elements.

The pulsating device 28 accumulates a specific volume of wastewater therein before dumping this specific volume in the distribution pipe 34. This causes the wastewater level to rise in the first filtration element 40A wetting the plastic discs 46 in that first filtration element 40A. The wastewater in the first filtration element 40A seeps into the second filtration element 40 through the walls 42 between the filtration elements 40, and so on until wastewater reaches the last downstream filtration element 40B, thereby wetting all the plastic discs 46 in the entire wastewater absorption bed 30.

The level 90 in all filtration elements 40 then starts to fall, exposing the plastic discs 46 to aeration. The period between the loads from the pulsating device 28 is selected to allow the wastewater level to drop sufficiently low to aerate the filtering media in all the filtration elements 40. The next load of wastewater from the pulsating device 28, causes a surge of wastewater into the filtration elements 40, wetting again the cavities of the plastic discs 46, and so on, exposing the plastic discs 46 to sequential wetting and drying of the discs 46 for promoting biological activities in the cavities of the plastic discs 46.

The outlet of the array of filtration elements 40 preferably empties into an outlet perforated pipe 92 that encircles the array of filtration elements 40. This perforated pipe 92, as shown in FIG. 2, delivers treated water of the absorption bed 30 more evenly into the base layer 50 and the soil 52 of the plateau 32.

It will also be understood that the resistance to flow through the walls of the filtration elements 40, increases gradually between the first 40A and the last filtration element 40B. Because slightly higher pressure is required for the effluent to seep into a downstream filtration element 40, this slightly higher pressure causes the level to rise in all the upstream filtration elements. This increase in resistance to flow inversely increases the resident time of the wastewater inside the upstream filtration elements 40, relative to the downstream ones. Because wastewater contains more foul matter in the upstream filtration elements 40, the increase in resident time of the wastewater in the upstream filtration elements 40 increases the exposure to microbial activity and associated treatment efficiency in the upstream filtration elements 40. More specifically, the wastewater remains exposed to microbiological activity in the first upstream filtration element 40A for a longer period than in the last downstream filtering element 40B. This phenomenon increases the treatment efficiency of the entire wastewater absorption bed 30.

The person skilled in the field of the present invention will also appreciate that the pulsating device 28 can also be installed downstream of the array of filtration elements 40, as shown by label 91 in FIG. 2, to release the content of the last filtration element 40B at irregular intervals to obtain the pulsating effect required to expose the content of all the filtration elements 40 to wetting and aeration in a sequential mode.

Because of the vertical structure of the wastewater absorption bed 30 according to the preferred embodiment of the present invention, and because of the increased efficiency due to the pulsating effect, and the resistance to flow mentioned above, it is believed that the wastewater absorption bed 30 according to the preferred embodiment is more efficient that the effluent absorption beds known in the art.

While one embodiment of the present invention has been illustrated in the accompanying drawings and described herein above, it will be appreciated by those skilled in the art that various modifications, alternate constructions and equivalents may be employed. Therefore, the above description and illustrations should not be construed as limiting the scope of the invention, which is defined in the appended claims.

What is claimed is:

1. A wastewater absorption bed for a septic treatment system, comprising:
an array of permeable filtration elements containing filtering media, said array or permeable filtration elements including a first upstream filtration element and a last downstream filtration element;
a plateau of granular materiel under said array of filtration elements;
an air-permeable layer above said array of filtration elements;
a wastewater delivery pipe mounted in said first filtration element;
a pulsating device connected to one of said wastewater delivery pipe and said downstream filtration element, for sequentially increasing and lowering a level of wastewater to be treated in said array of permeable filtration elements.

2. The wastewater absorption bed as claimed in claim 1, wherein said plateau of granular material comprises screened gravel or crushed rock material.

3. The wastewater absorption bed as claimed in claim 1, wherein said air-permeable layer comprises a sand layer and a perforated aeration pipe laid horizontally in said sand layer.

4. The wastewater absorption bed as claimed in claim 3, wherein said perforated aeration pipe includes a vertical segment extending above a soil surface.

5. The wastewater absorption bed as claimed in claim 1, wherein said pulsating device belong to a group of pulsating devices including a tipping bucket.

6. The wastewater absorption bed as claimed in claim 1, wherein said pulsating device has an inlet being fed from a septic reservoir.

7. The wastewater absorption bed as claimed in claim 1, further including a layer of top soil laid above said air-permeable layer.

8. The wastewater absorption bed as claimed in claim 7, further including a sheet of high-density polyethylene plastic mounted under said array of permeable filtration elements and a layer of woven geotextile material mounted between said air-permeable layer and said array of permeable filtration elements.

9. The wastewater absorption bed as claimed in claim 1, wherein said filtration elements are made of permeable non-woven geotextile material.

10. The wastewater absorption bed as claimed in claim 9, wherein each of said filtration elements have a three-dimensional rectangular shape.

11. The wastewater absorption bed as claimed in claim 10, wherein said pulsating device is a dosing pump or a tipping bucket.

12. The wastewater absorption bed as claimed in claim 1, wherein said filtering media is a plurality of plastic discs.

13. The wastewater absorption bed as claimed in claim 12, wherein said plastic discs contains a plurality of cavities and have properties to retain wastewater by capillary action.

14. The wastewater absorption bed as claimed in claim 13, wherein said cavities have a shape of honeycomb-like alveolations.

15. A pulsating wastewater absorption bed for a septic treatment system, comprising:
an array of permeable filtration elements containing filtering media, said array or permeable filtration elements including a first upstream filtration element and a last downstream filtration element;
a plateau of granular materiel under said array of filtration elements;
an air-permeable layer above said array of filtration elements;
a wastewater delivery pipe mounted in said first filtration element;
a pulsating device connected to said wastewater delivery pipe for delivering specific volumes of wastewater to be treated at timed intervals into said wastewater delivery pipe; and
said filtration elements having permeable walls there between, and said walls being mounted parallel to said wastewater delivery pipe, such that resistance to effluent flow there-through increases between said first upstream filtration elements and said last downstream filtration elements.

16. The pulsating wastewater absorption bed as claimed in claim 15, wherein said filtration elements are made of permeable non-woven geotextile material.

17. A method for treatment of wastewater in a wastewater absorption bed, comprising the following steps;
alternatively submerging filtering media in wastewater and exposing said filtering media to air.

18. The method as claimed in claim 17, further including the step of:
enclosing said filtering media in an array of permeable filtration elements, and causing said wastewater to flow through said array of filtration elements.

19. The method as claimed in claim 18, further including the step of: laying said array of filtration elements on a plateau of granular material and causing said wastewater from one of said filtration elements to flow into said plateau of granular material.

20. The method as claimed in claim 17, wherein said step of submerging comprises the step of delivering a specific volume of wastewater to said filtering media at time intervals.
